(19) United States
(12) Patent Application Publication
(10) Pub. No.: US 2017/0205025 A1
(43) Pub. Date: Jul. 20, 2017

(54) SCREEN-HOLDING STRUCTURE TO PREVENT SAGGING SCREEN PHENOMENON

(71) Applicant: CJ CGV CO., LTD., Seoul (KR)

(72) Inventors: Bon Il KOO, Seoul (KR); Byoung Jun SONG, Incheon (KR); Hae Jeong KOH, Seoul (KR); Min Jung KIM, Seoul (KR); Young Mi KIM, Seoul (KR); Ok Sun KIM, Seoul (KR); No Chan PARK, Incheon (KR); In Jae SEONG, Seoul (KR); Young Wook CHOI, Seoul (KR)

(21) Appl. No.: 15/326,464

(22) PCT Filed: Jul. 15, 2015
(86) PCT No.: PCT/KR2015/007351

§ 371 Date: Jan. 13, 2017

(30) Foreign Application Priority Data
Jul. 15, 2014 (KR) 10-2014-0089365
Jul. 15, 2015 (KR) 10-2015-0100289

(51) Int. Cl. F16M 11/22; F16M 11/18; E04B 1/19; F16B 47/00; F16M 11/04; E04H 3/22; G03B 21/606; F16B 1/00

(52) U.S. Cl. CPC F16M 11/22; G03B 21/606; F16M 11/18; F16B 1/00; F16B 47/00; F16M 11/04; E04H 3/22; E04B 1/19; F16B 2001/0035

(57) ABSTRACT

The present invention relates to a screen-holding structure, and more specifically to a screen-holding structure to withstand the weight of the screen by means of a screen holding apparatus for the entire region or a part of the screen to prevent the phenomenon in which a screen held by a frame sags downward due to the weight of the screen. According to the present invention, the curved surface of the screen can be smoothly maintained by minimizing the downward sagging phenomena of the curved screen, thereby allowing content image to be projected onto the screen without distortion, and consequently allowing a viewing environment having a high sense of immersion and enhanced stereoscopic effect to be provided to an audience.

### TECHNICAL FIELD

The present invention relates to a structure in which a screen is held and, more particularly, to a structure for holding a screen in which a screen holding apparatus holds weight of a screen with respect to some area of or the entire screen in order to prevent a phenomenon in which the screen held in a frame sags due to gravity.

According to the present invention, there are advantages in that a content image not having distortion can be projected on a screen because the curved surface of the screen can be smoothly maintained by minimizing a phenomenon in which the screen having curvature hangs down and thus a screening environment having a high sense of immersion and stereoscopic effect can be provided to audiences.

### BACKGROUND ART

In line with the recent diversification of movie content, a theater that is the space where the movie content can be watched is also greatly advanced. More specifically, many theaters consider various means in order to provide audiences with a higher three-dimensional (3-D) effect and a higher sense of immersion away from the frame of a screening environment in which a conventional 2-D image is projected.

Recently, active research is carried out on a 3-D imaging technology in order to provide an image having a 3-D effect. The 3-D imaging technology enables different images to enter the left and right eyes of an audience and enables the audience to have a three-dimensional effect in a process of the different images being recognized by the brain. In the 3-D imaging technology, two cameras on which different polarization filters have been mounted are used upon photographing and glasses on which polarization filters have been mounted are used when content is played back, so different images enter a left eye and a right eye.

However, such a 3-D technology can provide an audience with an image having a three-dimensional effect, but has a problem in that a degree of immersion into an image itself is low because an audience merely watches an image played back on a plane screen or a plane picture. Furthermore, there is a problem in that an audience must wear special glasses in order to watch a single piece of 3-D content in terms of audience convenience.

Meanwhile, in order to improve such an inconvenient screening environment, there has recently been made an attempt to provide an image through a screen of a shape other than a plane so as to provide a sense of immersion to audiences. That is, a theater is introduced in which a user can better feel a sense of immersion and a stereoscopic effect by providing an image through a screen having curvature in a specific direction other than a screen of a rectangle that is a conventional plane.

If the screen other than a plane is used as described above, the shape of the screen is not smooth because the material of the screen is not solid, generating a sagging phenomenon. Such a sagging phenomenon generates the distortion of a screen area, thus becoming a cause of not correctly projecting a content image.

Meanwhile, in order to provide audiences with a higher sense of immersion and stereoscopic effect, a screen deployment method in which a screen is inclined toward audiences at a specific angle or a screen deployment method for raising the top of a screen up to the ceiling may be taken into consideration. In the case of the screen deployment method, a sagging phenomenon attributable to weight of the screen is generated. Accordingly, there is a need for means for solving such a sagging phenomenon.

The present invention has been made to solve the aforementioned problems and also has been invented to satisfy the aforementioned technological needs and to provide additional technological elements that may not be easily invented by those skilled in the art.

### DISCLOSURE

### Technical Problem

An object of the present invention is to prevent a phenomenon in which a screen held in a frame hangs down due to gravity.

More specifically, an object of the present invention is to enable a screen to maintain a smooth projection surface without a sagging phenomenon using an apparatus for pulling a screen strap tied up to a frame and an apparatus for pulling a screen by generating an attractive force using a suction force, a magnetic force or an electrostatic force.

Furthermore, an object of the present invention is to enable a content image to be played back without distortion by preventing a phenomenon in which a screen hangs down and thus to enable audiences to feel a higher sense of immersion and stereoscopic effect. More specifically, an object of the present invention is to provide audiences with a stereoscopic effect generated because a projection distance is different for each screen area if a content image is projected on a screen having curvature in a long axis and a short axis and thus to enable audiences to feel a maximized sense of immersion when watching a 3-D content image so that even when the audiences watch a 2-D content image, the audiences feel the same stereoscopic effect as that when watching a 3-D content image.

Furthermore, an object of the present invention is to maintain the ovalness of a screen although the screen is inclined toward an audience and thus to provide audiences with a high sense of immersion because the distance between the audiences and the screen can be narrowed.

Furthermore, an object of the present invention is to concentrate even a sound, reflected by a screen, on audiences by implementing a screen of ovalness not having distortion.

### Technical Solution

A structure for holding a screen according to the present invention for solving the above problems includes a frame in which a screen is held; a strap for fixing the screen to the frame; and a screen holding apparatus having the strap extended and connected to the screen holding apparatus and pulling the extended and connected strap.

Furthermore, in the structure for holding a screen, the frame includes a pair of long-axis members formed in a first direction and a pair of short-axis members formed in a second direction. In this case, the long-axis members or the short-axis members have curvature of a specific size.

Furthermore, in this case, the screen holding apparatus may include a reel which winds and pulls the extended and connected strap and a motor which rotates the reel.

Furthermore, in the structure for holding a screen, the screen holding apparatus may include a pulley on which the extended and connected strap is hung.

Furthermore, in the structure for holding a screen, a single strap may be extended and connected to the screen holding apparatus or two or more straps may be extended and connected to the screen holding apparatus.

Meanwhile, in the structure for holding a screen, a plurality of the screen holding apparatuses may be provided within a theater.

A structure for holding a screen according to another embodiment of the present invention includes a screen; a frame in which the screen may be held; and a screen holding apparatus which generates an attractive force and endures the weight of the screen held in the frame.

Furthermore, in the structure for holding a screen, the frame includes a pair of long-axis members formed in a first direction and a pair of short-axis members formed in a second direction, and the long-axis members or the short-axis members have curvature of a specific size.

Furthermore, in the structure for holding a screen, the screen holding apparatus may include one or more suction holes and a suction unit which endures the weight of the screen by a suction force through the suction holes.

Furthermore, in the structure for holding a screen, the screen holding apparatus may include a magnetic unit which endures the weight of the screen by a magnetic force.

In this case, it is preferred that the screen includes an area on which a magnetic material has been coated.

Furthermore, in this case, the area on which the magnetic material has been coated may be an area to which sheet paper coated with the magnetic material has been attached.

Meanwhile, in the structure for holding a screen, the screen holding apparatus may include an electrostatic unit which endures the weight of the screen by an electrostatic force.

Furthermore, in the structure for holding a screen, the screen holding apparatus may include a ventilation unit which endures the weight of the screen by wind pressure generated by a wind and a ventilation hole which transmits the wind generated by the ventilation unit.

Meanwhile, in the structure for holding a screen according to each of the embodiments, the screen holding apparatus may be closely attached to the screen.

Furthermore, in the structure for holding a screen according to each of the embodiments, the frame further includes one or more assistant members, and the assistant member may have curvature of a specific size.

Furthermore, the screen holding apparatus may be provided on the assistant member.

Meanwhile, a screen holding apparatus according to yet another embodiment of the present invention is for preventing a phenomenon in which a screen held in a frame hangs down, and includes a holding unit which endures the weight of some area of or entire screen by pulling a strap provided in the screen or generating an attractive force.

In this case, in the screen holding apparatus, the holding unit may be a reel which winds and pulls the strap provided in the screen.

Furthermore, in the screen holding apparatus, the holding unit may be a suction unit which endures the weight of some area of or the entire screen by generating a suction force.

Furthermore, in the screen holding apparatus, the holding unit may be a magnetic unit which endures the weight of some area of or the entire screen by generating an attractive force according to a magnetic force.

Furthermore, in the screen holding apparatus, the holding unit may be an electrostatic unit which endures the weight of some area of or the entire screen by generating an attractive force according to an electrostatic force.

Furthermore, in the screen holding apparatus, the holding unit may be a ventilation unit which holds the weight of some area of or the entire screen by generating wind pressure according to a wind.

### Advantageous Effects

According to the present invention, there is an advantage in that a phenomenon in which a screen held in a frame hangs down due to gravity can be prevented.

Furthermore, according to the present invention, there is an advantage in that a screen can maintain a smooth projection surface without a sagging phenomenon by preventing a phenomenon in which the screen hangs down.

Furthermore, according to the present invention, there are advantages in that a phenomenon in which a screen hangs down can be minimized although the screen is held aslant or higher in order to provide an audience with a higher sense of immersion and thus an optimum screening environment can be provided to an audience.

Furthermore, according to the present invention, there is an advantage in that a sagging phenomenon can continue to be supplemented although it is generated due to the aging of a screen.

Furthermore, the present invention has advantages in that a content image can be played back without distortion by preventing a phenomenon in which a screen hangs down and thus audiences can feel a higher sense of immersion and stereoscopic effect. More specifically, the present invention has advantages in that it can provide audiences with a stereoscopic effect generated because a projection distance is different for each screen area if a content image is projected on a screen having curvature in a long axis and a short axis and thus enables audiences to feel a maximized sense of immersion when watching a 3-D content image so that even when the audiences watch a 2-D content image, the audiences feel the same stereoscopic effect as that when watching a 3-D content image.

Furthermore the present invention has advantages in that it can maintain the ovalness of a screen although the screen is inclined toward an audience and thus provide audiences with a high sense of immersion because the distance between the audiences and the screen can be narrowed.

Furthermore, the present invention has an advantage in that it can concentrate even a sound, reflected by a screen, on audiences by implementing a screen of ovalness not having distortion.

### DESCRIPTION OF DRAWINGS

FIG. 1 schematically shows an overall configuration of a theater that is the premise of the present invention.

FIG. 2 schematically shows a phenomenon in which part of the projection surface of a screen sags in a conventional theater environment.

FIG. 3 shows an example in which a screen and a frame are fixed using a strap.

FIG. 4 is a first embodiment of a screen holding apparatus and shows the state in which a strap fastened to a frame is extended and connected to the screen holding apparatus and is pulled by the screen holding apparatus.

FIG. 5 shows an example in which an assistant member has been included in the frame.

FIG. 6 is a second embodiment of the screen holding apparatus and shows the state in which the screen holding apparatus pulls the screen using a suction force.

FIG. 7 is a third embodiment of the screen holding apparatus and shows the state in which the screen holding apparatus pulls the screen using a magnetic force.

FIG. 8 is a fourth embodiment of the screen holding apparatus and shows the state in which the screen holding apparatus pulls the screen using an electrostatic force.

FIG. 9 is a fifth embodiment of the screen holding apparatus and shows the state in which the screen holding apparatus maintains the curved surface of the screen using wind pressure.

### MODE FOR INVENTION

The details of the objects and technological configurations of the present invention and acting effects thereof will be more clearly understood from the following detailed description based on the accompanying drawings. Hereinafter, embodiments of the present invention are described in detail with reference to the accompanying drawings.

Embodiments disclosed in this specification should not be interpreted as limiting or used to limit the range of right of the present invention. It is evident to those skilled in the art that a description including the embodiments of this specification has various applications. Accordingly, unless otherwise defined by the claims, some embodiments described are illustrative for better understanding, and the range of right of the present invention is not intended to be restricted by the embodiments.

Function blocks illustrated in the drawings and described hereunder are only examples of possible implementations. In other implementations, different functional blocks may be used without departing from the spirit and scope of the detailed description. Furthermore, one or more functional blocks of the present invention are illustrated as separate blocks, but one or more of the functional blocks of the present invention may be a combination of various hardware and software elements for executing the same function.

Furthermore, it should be understood that an expression that some elements are included is an expression of an open type and the expression simply denotes that the corresponding elements are present, but does not exclude additional elements.

Furthermore, when it is said that one element is connected or coupled to the other element, it should be understood that one element may be directly connected or coupled to the other element, but a third element may exist between the two elements.

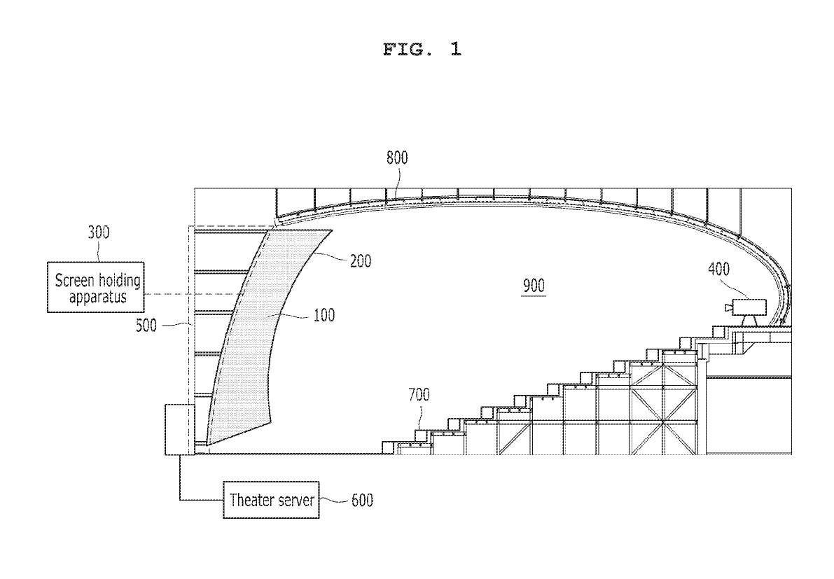

A general theater, that is, the background of the present invention, is described below with reference to FIG. 1 prior to a description of a structure for holding a screen 100 according to the present invention.

Referring to FIG. 1, the theater includes a screen 100, a frame 200 in which a screen 100 is held, and a screen holding apparatus 300 as basic elements. In the present detailed description, the three elements are in all defined as a single structure for holding the screen 100.

Meanwhile, the theater may further include a projector 400 for projecting a content image on the screen 100, a theater server 600 for providing a content image, seats 700 on which audiences can sit, a support 500 for supporting the frame 200 in which the screen 100 has been held, a ceiling 800 and the surface of a wall 900, in addition to the basic elements.

In the present invention, the screen 100 is a curtain which may be held in the frame 200, and generally refers to a thing that functions to reflect an image, projected by the projector 400, toward a surface. The materials of the screen 100 capable of reflecting a projected image as described above may include textiles or various kinds in which textiles have been subjected to coating treatment, such as mat white, glass beads, ultra beads, a film, fiber glass and diamond.

Meanwhile, a shape of the screen 100 of the present invention is not essentially limited to a plane. For example, the screen 100 according to the present invention may have curvature of a specific size in the long-axis or short-axis direction or may be implemented in the form of so-called ovalness having curvature of a specific size in both the long-axis and short-axis directions.

The reason why the screen 100 can maintain a shape not a plane as described above is that the shape of the frame 200 in which the screen 100 has been held has curvature of a specific size in the long axis or the short-axis direction. That is, in the present invention, in the theater that is a premise, the screen 100 is held in the frame 200 including a plurality of members having curvature of a specific size. Accordingly, the screen 100 is implemented in a shape not a plane, preferably, in the form of ovalness having curvature of a specific size in the long-axis and short-axis directions.

As may be seen from FIG. 1, the frame 200 according to the present invention includes a pair of long-axis members 210 formed in a first direction and a pair of short-axis members 230 formed in a second direction. The long-axis member 210 or the short-axis member 230 has curvature of a specific size. Furthermore, the screen 100 held in the frame 200 may be implemented in the form of a curve surface that is concave toward the seats 700. If curvature is implemented in the long axis or short axis of the screen 100 as described above, there is an advantage in that a higher sense of immersion and stereoscopic effect can be provided to audiences.

Next, the theater that is the premise of the present invention further includes the screen holding apparatus 300. The screen holding apparatus 300 means an apparatus for directly pulling a strap 110 extended from the screen 100 and connected thereto or some area of the screen 100 so that the screen 100 held in the frame 200 does not hangs down. The screen holding apparatus 300 may basically include a holding unit for directly pulling the strap or some area of the screen. The holding unit, as will be described later, may be implemented using various methods, such as a method for pulling a strap, a method for pulling a screen area using a suction force, a method for pulling a screen area using an attractive force such as a magnetic force or an electrostatic force, and a method for pushing a screen area using wind pressure according to ventilation.

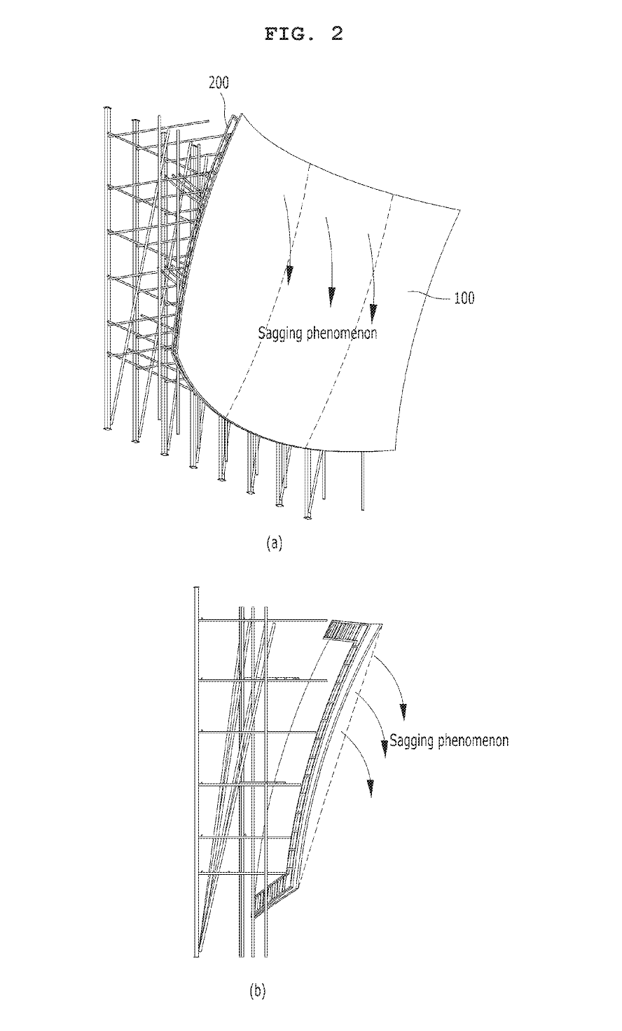

That is, the screen 100 according to the present invention has a problem in that part of the area of the screen 100 hangs down due to gravity because the screen 100 does not have a plane shape vertical to the ground unlike an existing screen 100. As described above, FIG. 2 shows the state in which distortion is generated in the projection surface of some area of the screen 100 held in the frame 200 (refer to FIG. 2(a)).

Furthermore, the screen 100 of ovalness according to the present invention can provide audiences with a more effective sense of immersion and stereoscopic effect as an installation location thereof is closer to the ceiling and the screen is more inclined toward the audiences. A sagging phenomenon in the screen 100 is more severely generated as the screen is more inclined toward the seats 700 high to the extent that the screen reaches the ceiling as described above.

If the screen 100 hangs down as described above, there is a problem in that a screen is distorted and viewed because a content image that has to be reflected toward audiences is reflected in a different direction. Accordingly, there is a problem in that audiences cannot normally watch a content image.

The present invention is for solving such a phenomenon in which the screen 100 sags, and embodiments for solving the problem are described below.

### First Embodiment

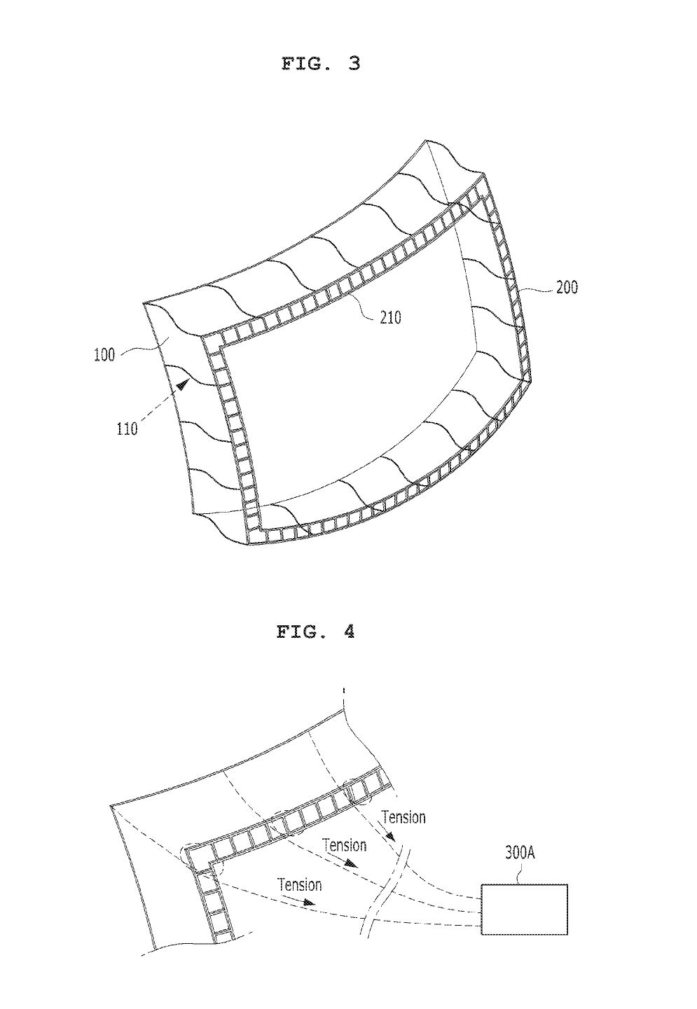

A first embodiment of a structure for holding the screen 100 according to the present invention is described below with reference to FIGS. 3 and 4.

The first embodiment is based on the premise that the screen 100 has been tied up to the frame 200 by the strap 110. In general, in a theater, the screen 100 is installed in such a way as to tie up the edges of the screen 100 to the frame 200 using the strap 110. According to another embodiment, the screen 100 is fabricated to have a smaller standard than the frame 200 so that a marginal portion of the screen 100 in the long axis and the short axis is wound and rolled on the frame 200. In this case, the screen 100 may be implemented so that the strap ties up and fixes the wound and rolled portion.

FIG. 3 shows an example in which the screen 100 is tied up to the frame 200 by the strap 110.

The strap 110 may be present with it being included in an edge of the screen 100 when the screen is fabricated or the straps 10 may be present in such a way as to be tied up to a plurality of holes perforated in an edge of the screen 100.

As described above, the strap 110 included in the edge of the screen 100 is tied up to the frame 200. In this case, it is preferred that the frame 200 is fabricated to have a form in which one pair of long-axis members 210 and the other pair of short-axis members 230 have four corners.

Meanwhile, how much the screen 100 can maintain a smooth curved surface or how much the sagging phenomenon of the screen is reduced is determined depending on how hard the strap 110 is tied up to the frame 200. In the present detailed description, strength by which the strap 110 is tied up to the frame 200 is described based on tension applied to the strap 110. That is, it is to be understood that the amount of tension applied to the strap 110 is an index indicating how hard the strap 110 is tied up to the frame 200.

FIG. 4 shows a structure for holding the screen 100 according to the present invention. The structure includes the screen 100, the frame 200 to which the screen 100 is tied up by the strap 110, and a screen holding apparatus 300A from and to which the strap 110 tied up to the frame 200 is extended and connected.

That is, the screen holding apparatus 300A of the first embodiment pulls any one strap 110 or a plurality of the straps 110 so that greater tension is applied to the strap 110 tied up to the frame 200.

Meanwhile, in a structure for holding the screen 100 according to the present invention, some or all of the straps 110 included in the screen 100 may be extended from the screen holding apparatus 300A and connected thereto. For example, two straps 110 tied up to left and right corners at the upper end of the screen 100 may be extended from the screen holding apparatus 300A and connected thereto. There may be an advantage in that the screen 100 is pulled by increasing the amount of tension applied to the two straps 110 through the driving of the screen holding apparatus 300A.

Meanwhile, a plurality of the screen holding apparatuses 300A may be present. For example, assuming that two straps 110 are provided in each of the four corners of the screen 100 and the straps 110 are tied up to the corresponding corners of the frame 200, the straps 110 at each corner may be extended and connected to a single screen holding apparatus 300A, that is, the straps 110 at the four corners may be extended and connected to the four screen holding apparatuses 300A. If the screen holding apparatus 300A is located at each of the corners of the screen 100 as described above, there is an advantage in that tension in an area (top/bottom/left/right) of the screen 100 required by a user can be increased by selectively driving the screen holding apparatus 300A.

Meanwhile, the screen holding apparatus 300A functions to pull the strap 110 may be implemented using various methods.

In a preferred implementation example of the screen holding apparatus 300A, the screen holding apparatus 300A may include a reel for winding and pulling the strap 110. The reel commonly refers to a tool which is used to wind a slim and long object. The edges of the reel may be formed to have a round wheel form in order to prevent the detachment of the strap 110.

In addition, the screen holding apparatus 300A may further include a motor for rotating the reel so that the reel performs a winding motion. That is, the screen holding apparatus 300A equipped with the reel and the motor receives external power and drives the motor. The reel that performs a winding motion by the motor winds and pulls the strap 110, so the screen 100 can maintain high tension.

On the one hand, the screen holding apparatus 300A may include only the reel without a motor. In this case, the reel may perform a winding motion by an external force. For example, a theater administrator may directly turn a handle included in the reel so that the reel performs a winding motion. Meanwhile, the screen holding apparatus has been illustrated as including only the strap and may be implemented to maintain tension of the screen when a theater administrator directly pulls the strap.

On the other hand, the screen holding apparatus 300A may include a pulley which is used to wind the strap 110. The pulley is a tool for changing the direction of a force applied to apply tension to the strap 110 or for more strongly pulling the strap 110 by only a relatively small force. The pulley may be connected to a winding apparatus driven by power like a motor or may be connected to only the strap 110 without a separate winding apparatus so that it can be pulled by a person's force without the driving of the motor.

### Second Embodiment

A structure for holding the screen 100 according to each of second to fourth embodiments includes the screen 100, the frame 200 in which the screen 100 is held, and the screen holding apparatus 300 for enduring the weight of the screen 100 held in the frame 200 by generating an attractive force, that is, for preventing a sagging phenomenon by pulling a sag area of the screen 100.

That is, unlike in the first embodiment, a structure for holding the screen 100 according to each of the second to fourth embodiments does not smoothly maintain a surface of the screen 100 by pulling the strap 110 included in the screen 100, but is focused on the prevention of a phenomenon in which the screen 100 hangs down by directly gripping an area in which the sag of the screen 100 is generated using an attractive force.

The structure for holding the screen 100 according to the second embodiment is described below with reference to FIG. 6.

In the second embodiment, a screen holding apparatus 300B has been implemented to endure the weight of an area that belongs to the screen 100 and that sags using a suction force. Referring to FIG. 6, the screen holding apparatus 300B according to the second embodiment includes one or more suction holes 310 and a suction unit 330 which endures the weight of the screen 100 using a suction force through the suction holes 310.

The suction holes 310 may be preferably provided so that they closely adhere to a sagging area of the screen 100. It is preferred that a plurality of the suction holes 310 is disposed at the backside of the screen 100 to cover all of the sagging areas of the screen 100. Furthermore, the size and number of suction holes 310 are not limited. In holding the screen 100 in the frame 200, the size and number of suction holes 310 capable of covering an area of the screen 100 in which a sagging phenomenon is generated may be disposed as long as the area of the screen 100 in which a sagging phenomenon is generated is present.

On the one hand, the suction unit 330 is a function unit for generating a suction force, that is, a force that sucks a thing. The suction unit 330 may include a motor therein.

On the other hand, the screen holding apparatus 300B including the suction unit 330 and the suction holes 310 may be provided at the backside of the screen 100. More specifically, the screen holding apparatus 300B may be provided in a form in which it is coupled or joined to members (the long-axis members 210 and the short-axis members 230) forming the frame 200.

Meanwhile, the frame 200 may further include an assistant member 250 in addition to the long-axis members 210 and the short-axis members 230. The screen holding apparatus 300B may also be provided on the assistant member 250. That is, in order to hold the screen 100 more strongly, the frame 200 may include the assistant member 250 in addition to the long-axis members 210 and the short-axis members 230. In this case, the assistant member 250 may be disposed in a direction parallel to the long-axis members 210 or the short-axis members 230 or a plurality of e assistant members 250 may be disposed in a third direction (e.g., a direction diagonal to the frame 200) unlike the long-axis members 210 or the short-axis members 230.

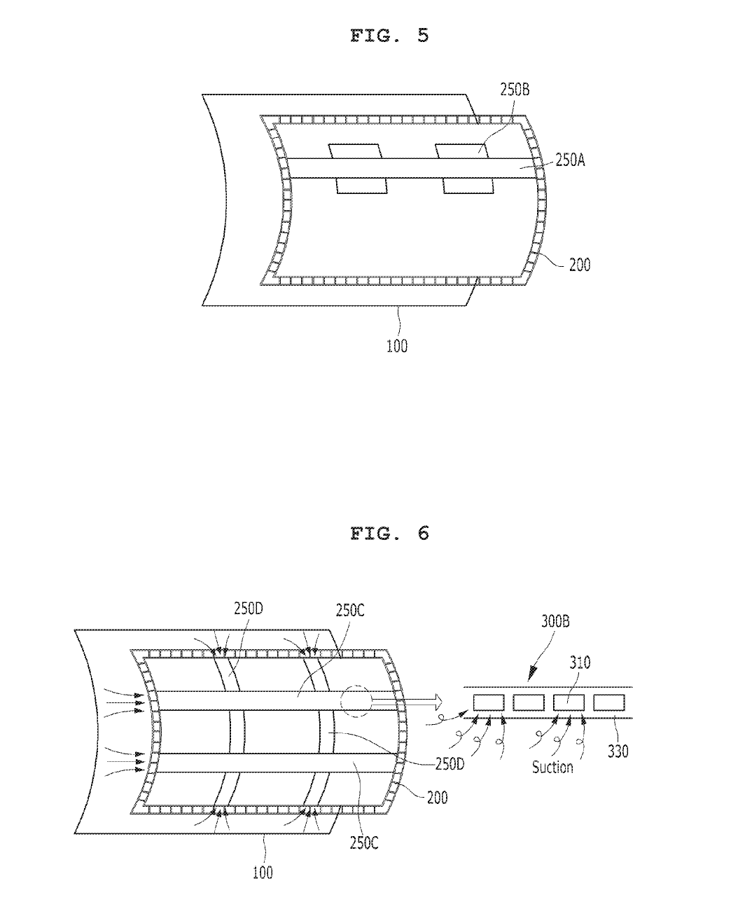

FIGS. 5 and 6 to be described later show embodiments in which the assistant member 250 has been included. In the first embodiment, the assistant member 250 has been provided in some area on the screen in which a sagging phenomenon is generated. From FIG. 5, it may be seen that the assistant member 250 is provided in an area in which a sagging phenomenon is generated, that is, an area on the upper side of the screen. In this case, the assistant member 250 includes a first assistant member 250A parallel to the long-axis members 210 and a second assistant member 250B and a third assistant member 250B engaged with the first assistant member 250A and each having a quadrangle. That is, as shown in FIG. 5, it should be understood that the assistant member may be partially provided for each area on the screen in which a sagging phenomenon is generated. The second embodiment is an embodiment in which the assistant members are generally closely provided on the screen. From FIG. 6, it may be seen that a plurality of assistant members 250C parallel to the long-axis members 210 and a plurality of assistant members 250D parallel to the short-axis members 230 are provided at the backside of the screen. That is, as in FIG. 6, the assistant members for holding the screen may be closely provided in order to prevent a general sagging phenomenon of the screen. In this case, it is to be understood that the assistant member 250 may be provided by combining the first embodiment and the second embodiment.

Meanwhile, if the screen holding apparatus 300B is provided on the assistant member 250, there is an advantage in that a more area of the screen 100 can be effectively gripped.

### Third Embodiment

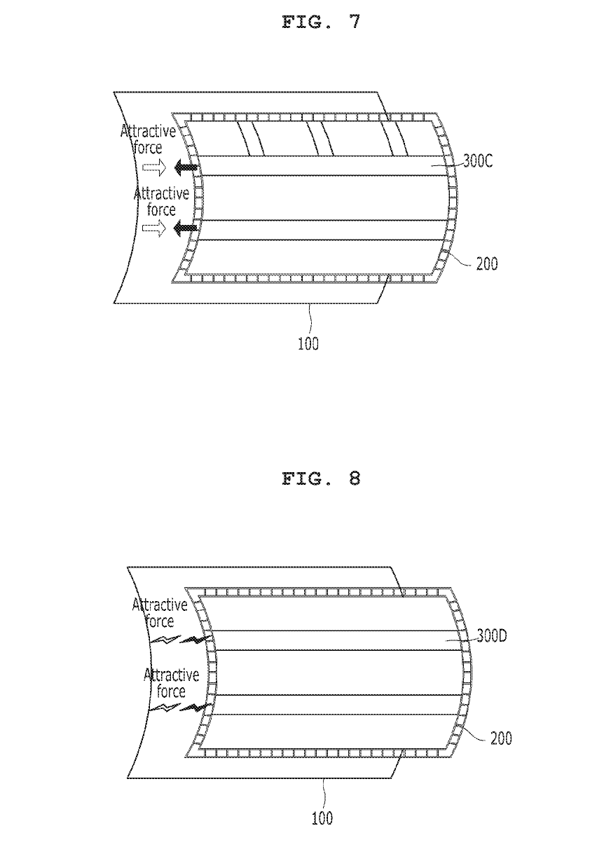

The structure for holding the screen 100 according to the third embodiment is described below with reference to FIG. 7.

Referring to FIG. 7, the screen holding apparatus 300C of a structure for holding the screen 100 has a technological characteristic in that it includes a magnetic unit which endures the weight of the screen 100 using a magnetic force. The magnetic unit refers to a member having a magnetic property. More specifically, the magnetic unit may be construed as including a magnet.

The screen holding apparatus 300C including the magnetic unit may be provided at the backside of the screen 100. More specifically, the screen holding apparatus 300C may be provided in a form in which it is coupled or joined to members (the long-axis members 210 and the short-axis members 230) forming the frame 200. Furthermore, in this case, the screen holding apparatus 300C may be provided on the assistant member 250 described in the second embodiment and closely attached to the backside of the screen 100.

Meanwhile, in order for the screen holding apparatus 300C to grip the screen 100 held in the frame 200 using a magnetic force, it is required that the screen 100 also have magnetism. Accordingly, in a structure for holding the screen 100 according to the third embodiment, it is required that the screen 100 be also coated with a material having magnetism, sheet paper coated with a material having magnetism be attached to the screen 100, or the screen 100 itself be made of a material having magnetism.

Meanwhile, the material having magnetism may be fabricated by a combination of various compositions. For example, the material may include at least one kind selected from the group consisting of Fe₂O₃, Fe₃O₄, BaO6Fe₂O₃, SrO6Fe₂O₃, FeOFe₂O₃, LiOFe₂O₃, NiOFe₂O₃, CuOFe₂O₃, MgOFe₂O₃, MnOFe₂O₃, Y₃Fe₅O₁₂, MnBi, FeNi, FeCo, CoNi, CrO₂, Mn—Zn-series ferrite, Ni—Zn-series ferrite, Mn—Mg—Zn-series ferrite, Ni—Cu—Zn-series ferrite, and Cu—Zn-series ferrite.

Meanwhile, a composition including a mixture of metal powder or magnetism powder 60˜95 wt % and binder resin 5˜40 wt % may be used as paints to be coated on the screen 100.

Preferably, the metal powder or magnetism powder may include a piece of powder or two or more pieces of powder selected from the group consisting of power, such as Sr-ferrite, Ba-ferrite, Mn—Zn ferrite, Ni-n ferrite, permalloy, supermalloy, sendust, Fe, Cu, Al, a neodymium-iron-boron alloy (NdFeB), and an aluminum-nickel-cobalt alloy (AlNiCo). More preferably, the metal powder or magnetism powder has a grain size of 0.1˜50 μm.

Furthermore, in this case, binder resin may include one or more liquid resins selected from the group consist of acryl resin, polyurethane resin, polyester resin, alkyd resin, fluoro resin, silicon resin, polycarbonate resin, polyamide resin, aldehyde resin and polyvinyl alcohol resin.

According to the third embodiment, some area of or the entire screen 100 may be implemented to have magnetism using the screen 100, paints for the screen 100 or sheet paper for the screen 100, which is made of the above composition. Accordingly, the screen holding apparatus 300C can endure the weight of the area of the screen 100 having magnetism, that is, can grip the area of the screen 100.

### Fourth Embodiment

The structure for holding the screen 100 according to the fourth embodiment is described below with reference to FIG. 8.

Referring to FIG. 8, in the structure for holding the screen 100 according to the fourth embodiment, a screen holding apparatus 300D has a technological characteristic in that it includes an electrostatic unit which endures the weight of the screen 100 using an electrostatic force. The electrostatic unit refers to a member with which electric charges have been charged.

The screen holding apparatus 300D including the electrostatic unit may be provided at the backside of the screen 100. More specifically, the screen holding apparatus 300D may be provided in a form in which it has been coupled or joined to members (the long-axis members 210 and the short-axis members 230) forming the frame 200. Furthermore, in this case, the screen holding apparatus 300D may be provided on the assistant member 250 described in the second embodiment and closely attached to the backside of the screen 100.

Meanwhile, in order for the screen holding apparatus 300D to grip the screen 100 held in the frame 200 using an electrostatic force, it is required that the screen 100 also have static electricity. Accordingly, in the structure for holding the screen 100 according to the fourth embodiment, the screen 100 is also charged with electric charges. In this case, it is required that the electric charges charged in the screen 100 have polarity opposite the polarity of electric charges charged in the electrostatic unit.

### Fifth Embodiment

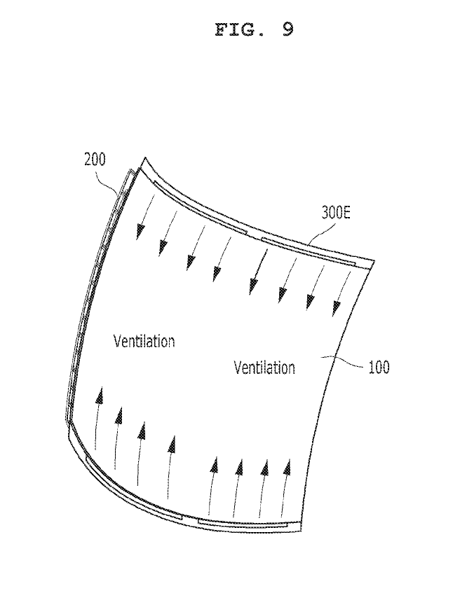

The structure for holding the screen 100 according to the fifth embodiment is described below with reference to FIG. 9.

Referring to FIG. 9, in the structure for holding the screen 100 according to the fifth embodiment, a screen holding apparatus 300E performs a ventilation function. That is, as may be seen from FIG. 9, the screen holding apparatus 300E is disposed to perform ventilation along the surface of the screen 100, and thus functions to support a sagged area of the screen 100 by wind power.

The screen holding apparatus 300E includes a ventilation unit, that is, a device generating a wind, and a ventilation hole which discharges the generated wind. The ventilation unit basically generates a wind according to the same principle as that of a fan. The ventilation hole functions to transmit a wind generated by the ventilation unit.

Meanwhile, the screen holding apparatus 300E according to the fifth embodiment may be preferably disposed to be parallel to the long axis of the screen 100 at the lower end of the screen (or the frame) or the upper end of the screen (or the frame). In this case, the direction of the ventilation hole may be directed toward the front of the screen 100 so that wind pressure prevents a phenomenon in which the screen 100 sags.

Although some embodiments and application examples of the present invention have been illustrated and described above, the present invention is not limited to the aforementioned specific embodiments and application examples and may be modified in various ways by those skilled in the art to which the present invention pertains without departing from the gist of the present invention written in the claims. Such modified embodiments should not be construed as being distinct from the technological spirit or prospect of the present invention.

1-24. (canceled)

25. A structure for holding a screen, comprising:
a frame in which a screen is held;
a strap for fixing the screen to the frame; and
a screen holding apparatus pulling the strap.

26. The structure of claim 25, wherein:
the frame comprises a pair of long-axis members formed in a first direction and a pair of short-axis members formed in a second direction, and
the long-axis members or the short-axis members have curvature of a specific size.

27. The structure of claim 26, wherein the screen holding apparatus comprises:
a reel which winds and pulls the strap; and
a motor which rotates the reel.

28. The structure of claim 26, wherein the screen holding apparatus comprises a pulley on which the strap is hung.

29. The structure of claim 25, wherein one or more straps are extended and connected to the screen holding apparatus.

30. A structure for holding a screen, comprising:
a screen;
a frame in which the screen is held; and
a screen holding apparatus which generates an attractive force and endures a weight of the screen held in the frame.

31. The structure of claim 30, wherein:
the frame comprises a pair of long-axis members formed in a first direction and a pair of short-axis members formed in a second direction, and
the long-axis members or the short-axis members have curvature of a specific size.

32. The structure of claim 31, wherein the screen holding apparatus comprises:
one or more suction holes; and
a suction unit which endures the weight of the screen by a suction force through the suction holes.

33. The structure of claim 31, wherein the screen holding apparatus comprises a magnetic unit which endures the weight of the screen by a magnetic force.

34. The structure of claim 33, wherein the screen comprises an area on which a magnetic material has been coated or an area to which sheet paper coated with a magnetic material has been attached.

35. The structure of claim 31, wherein the screen holding apparatus comprises an electrostatic unit which endures the weight of the screen by an electrostatic force.

36. The structure of claim 31, wherein the screen holding apparatus comprises:
a ventilation unit which endures the weight of the screen by wind pressure generated by a wind; and
a ventilation hole which transmits the wind generated by the ventilation unit.

37. The structure of claim 31, wherein:
the frame further comprises one or more assistant members, and
the assistant member has curvature of a specific size.

38. The structure of claim 37, wherein the screen holding apparatus is provided on the assistant member.

39. A screen holding apparatus for preventing a screen held in a frame from hanging down, the screen holding apparatus comprising:
a holding unit which endures a weight of some area of or entire screen by pulling a strap provided in the screen or generating an attractive force.

40. The screen holding apparatus of claim 39, wherein the holding unit is a reel which winds and pulls the strap provided in the screen.

41. The screen holding apparatus of claim 40, wherein the holding unit is a suction unit which endures the weight of some area of or the entire screen by generating a suction force.

42. The screen holding apparatus of claim 40, wherein the holding unit is a magnetic unit which endures the weight of some area of or the entire screen by generating an attractive force according to a magnetic force.

43. The screen holding apparatus of claim 40, wherein the holding unit is an electrostatic unit which endures the weight of some area of or the entire screen by generating an attractive force according to an electrostatic force.

44. The screen holding apparatus of claim 40, wherein the holding unit is a ventilation unit which holds the weight of some area of or the entire screen by generating wind pressure according to a wind.
